(19) United States
(12) Patent Application Publication
(10) Pub. No.: US 2025/0253437 A1
(43) Pub. Date: Aug. 7, 2025

(54) IMMERSION COOLING BATTERY ARRAY ENCLOSURE

(71) Applicant: Ford Global Technologies, LLC, Dearborn, MI (US)

(72) Inventor: Jie Deng, Novi, MI (US)

(21) Appl. No.: 18/435,224

(22) Filed: Feb. 7, 2024

(51) Int. Cl. H01M 10/6568; B60L 50/60; H01M 10/613; H01M 10/625; H01M 50/211; H01M 50/271; H01M 50/291

(52) U.S. Cl. CPC H01M 10/6568; H01M 10/613; H01M 10/625; H01M 50/211; H01M 50/271; H01M 50/291; B60L 50/60; H01M 2220/20

(57) ABSTRACT

An assembly includes a first housing component and a second housing component cooperating with the first housing component to provide an enclosed internal cavity. At least one cell stack includes one or more battery cells that are positioned within the enclosed internal cavity. A first plurality of guide features are formed on at least one of the first housing component and the second housing component, and a second plurality of guide features are formed on the at least one of the first housing component and the second housing component.

### TECHNICAL FIELD

This disclosure relates generally to a battery array enclosure structure assembly adapted for immersion cooling a battery array of a traction battery pack, and more specifically relates to an enclosure structure assembly that includes multiple sets of flow guide features.

### BACKGROUND

Electrified vehicles are one type of vehicle that reduce automotive fuel consumption and emissions. In general, electrified vehicles differ from conventional motor vehicles, which are driven by internal combustion engines, because the electrified vehicles are selectively driven by one or more battery powered electric machines. A high voltage traction battery pack typically powers the electric machines and other electrical loads of the electrified vehicle. The traction battery pack may include one or more groupings of interconnected battery cells. Thermal management systems may be used to facilitate control of thermal characteristics of the traction battery pack.

### SUMMARY

An assembly according to an exemplary aspect of the present disclosure includes, among other things: a first housing component; a second housing component cooperating with the first housing component to provide an enclosed internal cavity; at least one cell stack including one or more battery cells positioned within the enclosed internal cavity; a first plurality of guide features formed on at least one of the first housing component and the second housing component; and a second plurality of guide features formed on the at least one of the first housing component and the second housing component.

In a further non-limiting embodiment of the foregoing assembly, the first housing component comprises a battery enclosure top cover, and wherein the second housing component comprises a battery enclosure bottom cover.

In a further non-limiting embodiment of any of the foregoing assemblies, the first plurality of guide features comprise mechanical supports for the one or more battery cells.

In a further non-limiting embodiment of any of the foregoing assemblies, the at least one of the first housing component and the second housing component comprises an inner surface that faces the enclosed internal cavity, and wherein the first plurality of guide features comprise discrete elongated bodies that extend outwardly of the inner surface to provide fluid flow channels.

In a further non-limiting embodiment of any of the foregoing assemblies, the second plurality of guide features extend outwardly of the inner surface and comprise a plurality of discrete protrusions or dimples that are spaced apart from each other within the fluid flow channels.

In a further non-limiting embodiment of any of the foregoing assemblies, the discrete elongated bodies are defined by a first height relative to the inner surface and the plurality of discrete protrusions or dimples are defined by a second height relative to the inner surface, wherein the second height is less than the first height.

In a further non-limiting embodiment of any of the foregoing assemblies, the at least one of the first housing component and the second housing component comprises an inner surface that faces the enclosed internal cavity, and wherein the first plurality of guide features comprise mechanical supports for the one or more battery cells, and wherein the first plurality of guide features comprise discrete elongated bodies that extend outwardly of the inner surface to provide fluid flow channels.

In a further non-limiting embodiment of any of the foregoing assemblies, the assembly includes a thermal interface material between the first plurality of guide features and the one or more battery cells.

In a further non-limiting embodiment of any of the foregoing assemblies, the discrete elongated bodies each extend away from the inner surface to a distal surface, and wherein the thermal interface material covers the distal surface.

In a further non-limiting embodiment of any of the foregoing assemblies, the at least one of the first housing component and the second housing component comprises an inner surface that faces the enclosed internal cavity, wherein the first plurality of guide features are defined by a first height relative to the inner surface and the second plurality of guide features are defined by a second height relative to the inner surface, wherein the second height is less than the first height.

In a further non-limiting embodiment of any of the foregoing assemblies, the other of the first housing component and the second housing component includes a set of the first plurality of guide features and a set of the second plurality of guide features.

In a further non-limiting embodiment of any of the foregoing assemblies, the first plurality of guide features comprises a plurality of primary protrusions extending away from an enclosure surface and the second plurality of guide features comprises a plurality of secondary protrusions extending away from the enclosure surface and that have a different height from the plurality of primary protrusions relative to the enclosure surface.

In a further non-limiting embodiment of any of the foregoing assemblies, each primary protrusion comprises an elongated body that provides support to the one or more battery cells, and wherein adjacent primary protrusions are spaced apart from each other to define fluid flow channels, and wherein the plurality of secondary protrusions comprise discrete dimples that are spaced apart from each other within the fluid flow channels.

A method according to another exemplary aspect of the present disclosure includes, among other things: providing a first housing component and a second housing component that cooperates with the first housing component to provide an enclosed internal cavity; positioning at least one cell stack including one or more battery cells within the enclosed internal cavity; forming a first plurality of guide features on at least one of the first housing component and the second housing component; and forming a second plurality of guide features on the at least one of the first housing component and the second housing component.

In a further non-limiting embodiment of the foregoing method, the at least one of the first housing component and the second housing component comprises an inner surface that faces the enclosed internal cavity, and the method includes: defining the first plurality of guide features with a first height relative to the inner surface; and defining the second plurality of guide features with a second height relative to the inner surface, wherein the second height is less than the first height.

In a further non-limiting embodiment of any of the foregoing methods, the at least one of the first housing component and the second housing component comprises an inner surface that faces the enclosed internal cavity, and the method includes forming the first plurality of guide features as mechanical supports for the one or more battery cells.

In a further non-limiting embodiment of any of the foregoing methods, the method includes forming the first plurality of guide features as discrete elongated bodies that extend outwardly of the inner surface to provide fluid flow channels.

In a further non-limiting embodiment of any of the foregoing methods, the discrete elongated bodies each extend away from the inner surface to a distal surface, and the method includes covering the distal surface with a thermal interface material and forming an isolating structure between the first plurality of guide features and the one or more battery cells.

In a further non-limiting embodiment of any of the foregoing methods, the other of the first housing component and the second housing component includes a set of the first plurality of guide features and a set of the second plurality of guide features.

In a further non-limiting embodiment of any of the foregoing methods, the first housing component and the second housing component comprise an inner surface that faces the enclosed internal cavity, and the method includes: forming the first plurality of guide features as a plurality of primary protrusions extending away from the inner surface, wherein each primary protrusion comprises an elongated body that provides support to the one or more battery cells, and wherein adjacent primary protrusions are spaced apart from each other to define fluid flow channels; and forming the second plurality of guide features as a plurality of secondary protrusions extending away from the inner surface and that have a different height from the plurality of primary protrusions, wherein the plurality of secondary protrusions comprise discrete dimples that are spaced apart from each other within the fluid flow channels.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 schematically illustrates an electrified vehicle.

FIG. 2 illustrates a traction battery pack of the electrified vehicle of FIG. 1.

FIG. 3 illustrates an exploded view of the traction battery pack of FIG. 2.

FIG. 4A is an enlarged view of a portion of an inner surface of a bottom cover of the traction battery pack.

FIG. 4B is a section view taken along lines 4B-4B as shown in FIG. 4A.

FIG. 5A is a bottom view of a top cover of the traction battery pack.

FIG. 5B is an enlarged view of a portion of an inner surface of the top cover of the traction battery pack.

### DETAILED DESCRIPTION

This disclosure details a battery array enclosure structure assembly adapted for immersion cooling a battery array of a traction battery pack. The enclosure structure assembly includes multiple sets of flow guide features to facilitate thermal management for the traction battery pack. These and other features are discussed in greater detail in the following paragraphs of this detailed description.

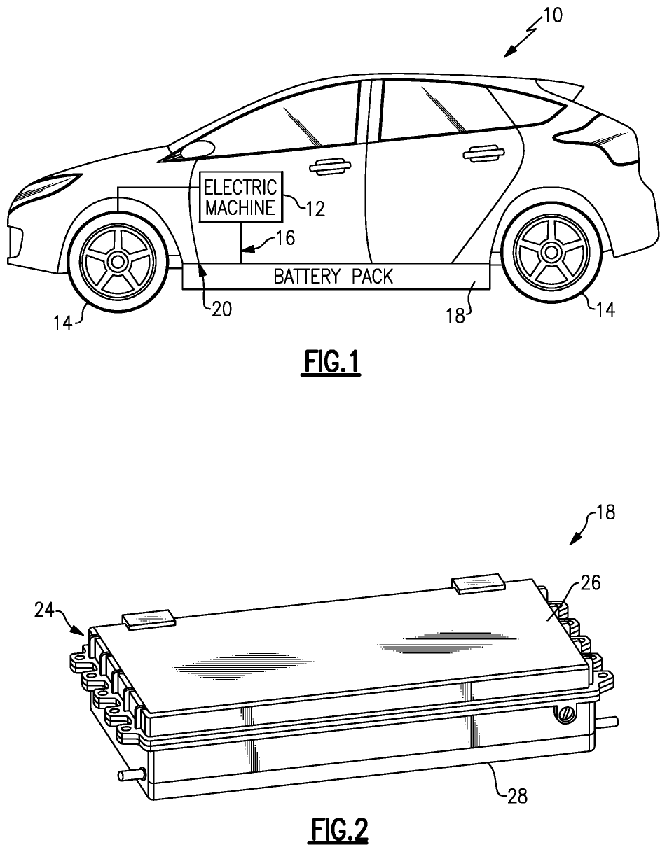

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

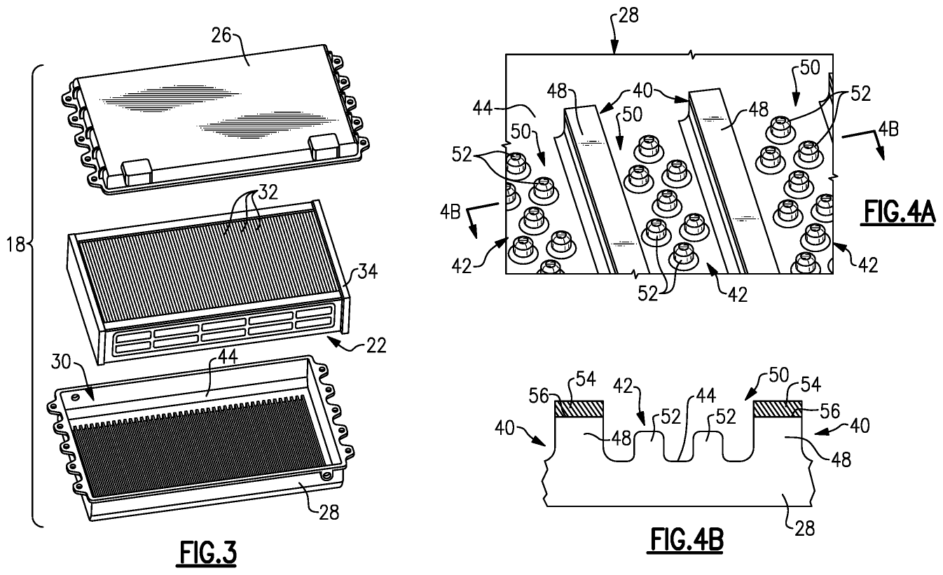

FIGS. 2 and 3 illustrate additional details associated with the traction battery pack 18 of the electrified vehicle 10. The traction battery pack 18 may include one or more cell stacks 22 housed within an interior area 30 of a battery housing enclosure assembly 24. The enclosure assembly 24 includes at least a first housing component 26 and a second housing component 28 that cooperate with each other to define an enclosed internal cavity 30 of the traction battery pack 18. In one example, the first housing component 26 may comprise an enclosure top cover 26 and the second housing component 28 may comprise an enclosure tray or bottom cover 28. The enclosure cover 26 may be secured (e.g., bolted, welded, adhered, etc.) to the enclosure tray or bottom cover 28 to provide the interior area 30 for housing the cell stacks 22 and other battery internal components (e.g., busbars, control modules and other electronics, etc.) of the traction battery pack 18. The size, shape, and configuration of the enclosure assembly 24 may vary within the scope of this disclosure.

Each cell stack 22 may include a plurality of individual battery cells 32 that are within the enclosed internal cavity 30. The battery cells 32 store and supply electrical power for powering various components in order to support the electric propulsion of the electrified vehicle 10.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure.

Although a specific number of cell stacks 22 and battery cells 32 are illustrated in the various figures of this disclosure, the traction battery pack 18 could include any number of the cell stacks 22, with each cell stack 22 having any number of individual battery cells 32. The battery cells 32 of each cell stack 22 may be stacked side-by-side relative to one another along a cell stack axis. The battery cells 32 may be arranged such that the faces of one battery cell are in direct contact with one of the faces of a neighboring battery cell 32 of the cell stack 22. The battery cells 32 may be held in compression relative to one another within the cell stack 22 to provide the face-to-face cell arrangement. Support and/or compression may be applied by a support structure 34 of the cell stack 22, for example. However, other configurations are contemplated within the scope of this disclosure. The support structure 34 may include any combination of plates, walls, crossmembers, beams, bindings, etc.

In one example, the traction battery pack 18 utilizes immersion cooling, which has the benefits of facilitating cooling efficiency and thermal propagation mitigation performance. To take advantage of these benefits, a contact area between coolant and the battery cells 32, and between the coolant and the thermally conductive enclosure components 26, 28, should be maximized. However, the battery cells 32 in an array need to be supported mechanically due to their weight. The supporting structure and coolant flow domain occupy the same space. In addition, due to the constraint of packaging space, the cross-sectional area of coolant flow channels is limited, which may affect the cooling efficiency. The subject disclosure provides a configuration that simultaneously supports the battery cells 32, provides space for coolant to cool the battery cells 32, and increases the cooling efficiency within limited space.

In one example, a first plurality of guide features 40 and a second plurality of guide features 42 are formed on at least one of the first housing component 26 and the second housing component 28. As discussed above, in one example, the first housing component comprises a battery enclosure top cover 26, and the second housing component comprises a battery enclosure bottom cover 28.

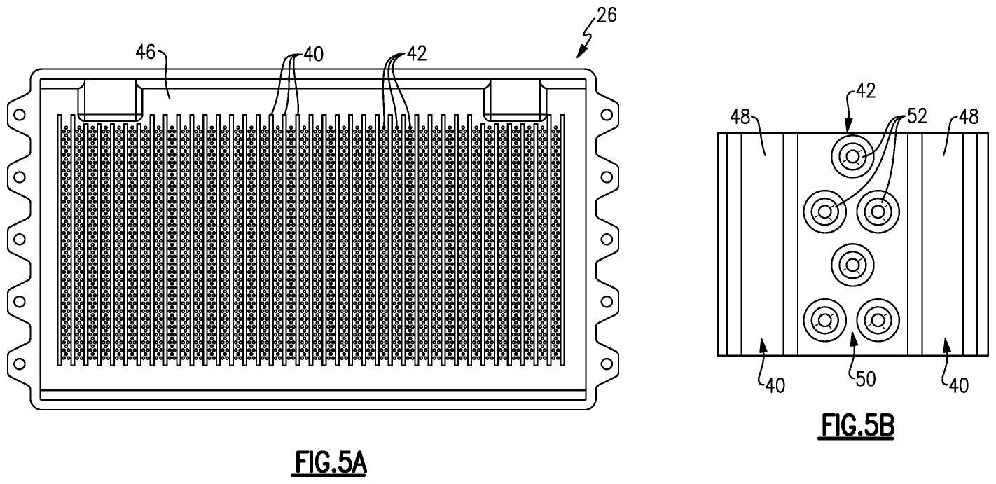

The bottom cover 28 includes an inner surface 44 (FIGS. 4A-4B) that faces the enclosed internal cavity 30 and the top cover 26 includes an inner surface 46 (FIGS. 5A-5B) that faces the enclosed internal cavity 30. In one example, each of the top cover 26 and the bottom cover 28 include the first plurality of guide features 40 and the second plurality of guide features 42. In one example, the first plurality of guide features 40 comprise a primary set of guiding and cooling features and the second plurality of guide features comprise a secondary set of guiding and cooling features.

In one example, the first plurality of guide features 40 comprise mechanical supports for the one or more battery cells 32. The mechanical supports extend from the respective inner surface (44 and/or 46) of the cover (26 and/or 28) to contact the battery cells 32 and structurally support them.

As shown in FIG. 4A, in one example the first plurality of guide features 40 comprise protrusions such as discrete elongated bodies 48 that extend outwardly of the inner surface 44 of the bottom cover 28 to provide a plurality of fluid flow channels 50. The elongated bodies 48 are spaced apart from each other across the inner surface 44. The fluid flow channels 50 are formed within gaps created between the elongated bodies 48.

In one example, the second plurality of guide features 42 extend outwardly of the inner surface 44 of the bottom cover 28 and comprise protrusions such as a plurality of discrete dimples 52 that are spaced apart from each other within the fluid flow channels 50. The dimples 52 help to increase the cooling efficiency by disturbing the coolant flow and increasing turbulence. The dimples 52 also increase cooling efficiency by increasing the contact area between the enclosure cavity 30, e.g., a thermal sink, and coolant circulating within the cavity 30. In certain events, such as thermal propagation for example, the dimples 52 help to cool down venting gas temperature by increasing the mixing between the coolant and venting gas, and increasing the contact area between the enclosure and the venting gas. Although adding the secondary dimples 52 slightly increases the coolant pressure drop across the enclosure, it does not affect the coolant pump performance since the pressure drop in enclosure is a small fraction of the total pressure drop of coolant in the entire vehicle thermal system.

In one example, the elongated bodies 48 are defined by a first height H1 relative to the inner surface 44 and the plurality of discrete dimples 52 are defined by a second height H2 relative to the inner surface 44. In one example, the first H1 and second H2 heights are different from each other. In one example, the second height H2 is less than the first height H1. Having the second height H2 be less than the first height H1 facilitates the creation of turbulent flow within the fluid flow channels 50.

In one example, the first plurality of guide features 40 and the second plurality of guide features 42 that cooperate with each other to provide two different tiers of features that facilitate guiding the coolant, as well as improving cooling efficiency. The number, shape, size, and pattern of the features 40, 42 of the two different tiers depend on the requirements of cell support, cooling efficiency, and mixing efficiency.

FIGS. 5A-5B show the example of the top cover 26 including both the first plurality of guide features 40 and the second plurality of guide features 42. The elongated bodies 48 and the plurality of discrete dimples 52 extend away from the inner surface 46 of the top cover 26 in a manner similar as that described above relative to the bottom cover 28.

The covers 26, 28 may be made from a conduction material such as metal, for example. In one example, a thermal interface layer of material 54 (FIG. 4B) is provided between the first plurality of guide features 40 and the one or more battery cells 32. The use of the thermal interface layer of material 54 helps isolate the conductive covers 26, 28 from the battery cells 32. In one example shown in FIG. 4B, the discrete elongated bodies 48 each extend away from the inner surface 44 to a distal end surface 56. In one example, the thermal interface layer of material 54 covers the distal surface 56. In one example, the thermal interface layer of material 54 is only associated with first plurality of guide features 40. In one example, only the distal surface 56 is covered with the thermal interface layer of material 54.

The following are examples of the interface material: thermal paste; thermal adhesive; thermal gap filler; or other similar materials. The interface material should be thermally conductive to transfer heat, have a sticky texture to increase cell retention capability, and be thicker than a predetermined value to provide electrical insulation between the battery cells and the cover.

In one example, a method includes: providing a first housing component and a second housing component that cooperates with the first housing component to provide an enclosed internal cavity; positioning at least one cell stack including one or more battery cells within the enclosed internal cavity; forming a first plurality of guide features on at least one of the first housing component and the second housing component; and forming a second plurality of guide features on the at least one of the first housing component and the second housing component.

The method may also include any of the following steps either alone or in any combination. For example, the method may include the at least one of the first housing component and the second housing component comprising an inner surface that faces the enclosed internal cavity, and the method further including: defining the first plurality of guide features with a first height relative to the inner surface; and defining the second plurality of guide features with a second height relative to the inner surface, wherein the second height is less than the first height.

For example, the method may include forming the first plurality of guide features as mechanical supports for the one or more battery cells.

For example, the method may include forming the first plurality of guide features as discrete elongated bodies that extend outwardly of the inner surface to provide fluid flow channels.

For example, the method may include the discrete elongated bodies each extending away from the inner surface to a distal surface, and the method further includes covering the distal surface with a thermal interface material and forming an isolating structure between the first plurality of guide features and the one or more battery cells.

For example, the method may include the other of the first housing component and the second housing component including a set of the first plurality of guide features and a set of the second plurality of guide features.

For example, the method may include: forming the first plurality of guide features as a plurality of primary protrusions extending away from the inner surface, wherein each primary protrusion comprises an elongated body that provides support to the one or more battery cells, and wherein adjacent primary protrusions are spaced apart from each other to define fluid flow channels; and forming the second plurality of guide features as a plurality of secondary protrusions extending away from the inner surface and that have a different height from the plurality of primary protrusions, wherein the plurality of secondary protrusions comprise discrete dimples that are spaced apart from each other within the fluid flow channels.

The subject disclosure provides a battery array enclosure, e.g., top and bottom covers, that have two tiers of protrusions/dimples with different heights. The primary tier, e.g., the first tier, of protrusions are used to support the cells, and the space between the protrusions creates the coolant flow channels that allow coolant to directly contact the cell edges. Between the primary protrusions and the battery cells, a layer of interface material may be added to isolate the cells from the electrically conductive enclosure. Inside of each coolant channel created by the primary protrusions, the secondary tier, e.g., the second tier, of dimples are added. The dimples are shorter than the primary protrusions and do not contact the cells. The dimples are used to disturb the coolant flow and increase its turbulence, which helps to increase the cooling efficiency. Moreover, the secondary dimples increase the contact area between coolant and enclosure. Since the enclosure is typically made from metal and acts as a thermal sink, a larger contact area between the enclosure and coolant helps to take heat from the coolant more rapidly, which further increases the cooling capability of the coolant. In the event of thermal propagation, hot venting gas comes out of cells. The secondary dimples can increase the mixing efficiency between the gas and coolant, and increase the contact area between the gas and enclosure, which helps to cool down the venting gas and reduce the thermal propagation speed.

Adding the secondary dimples slightly increases the pressure drop of coolant across the array. The computational fluid dynamics analysis shows that in this example of dimple patterns, adding the secondary dimples increases the heat transfer coefficient between cells and coolant by about 7%. The pressure drop across the enclosure increases about 10% after adding the secondary dimples. Compared with the conventional cold plate cooling, the resistance of coolant flow in the enclosure is much smaller than that in the cold plate coolant channels, so the pressure drop of coolant in the enclosure is lower than that in the cold plate. As such, the pressure drop in array is not a main contributor to the pressure drop of coolant in the entire vehicle thermal system. Because of that, the increase of pressure drop due to secondary dimples will not affect the coolant pump performance significantly.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An assembly comprising:
a first housing component;
a second housing component cooperating with the first housing component to provide an enclosed internal cavity;
at least one cell stack including one or more battery cells positioned within the enclosed internal cavity;
a first plurality of guide features formed on at least one of the first housing component and the second housing component; and
a second plurality of guide features formed on the at least one of the first housing component and the second housing component.

2. The assembly of claim 1, wherein the first housing component comprises a battery enclosure top cover, and wherein the second housing component comprises a battery enclosure bottom cover.

3. The assembly of claim 1, wherein the first plurality of guide features comprise mechanical supports for the one or more battery cells.

4. The assembly of claim 1, wherein the at least one of the first housing component and the second housing component comprises an inner surface that faces the enclosed internal cavity, and wherein the first plurality of guide features comprise discrete elongated bodies that extend outwardly of the inner surface to provide fluid flow channels.

5. The assembly of claim 4, wherein the second plurality of guide features extend outwardly of the inner surface and comprise a plurality of discrete protrusions or dimples that are spaced apart from each other within the fluid flow channels.

6. The assembly of claim 5, wherein the discrete elongated bodies are defined by a first height relative to the inner surface and the plurality of discrete protrusions or dimples are defined by a second height relative to the inner surface, wherein the second height is less than the first height.

7. The assembly of claim 1, wherein the at least one of the first housing component and the second housing component comprises an inner surface that faces the enclosed internal cavity, and wherein the first plurality of guide features comprise mechanical supports for the one or more battery cells, and wherein the first plurality of guide features comprise discrete elongated bodies that extend outwardly of the inner surface to provide fluid flow channels.

8. The assembly of claim 7, including a thermal interface material between the first plurality of guide features and the one or more battery cells.

9. The assembly of claim 8, wherein the discrete elongated bodies each extend away from the inner surface to a distal surface, and wherein the thermal interface material covers the distal surface.

10. The assembly of claim 1, wherein the at least one of the first housing component and the second housing component comprises an inner surface that faces the enclosed internal cavity, wherein the first plurality of guide features are defined by a first height relative to the inner surface and the second plurality of guide features are defined by a second height relative to the inner surface, wherein the second height is less than the first height.

11. The assembly of claim 1, wherein the other of the first housing component and the second housing component includes a set of the first plurality of guide features and a set of the second plurality of guide features.

12. The assembly of claim 11, wherein the first plurality of guide features comprises a plurality of primary protrusions extending away from an enclosure surface and the second plurality of guide features comprises a plurality of secondary protrusions extending away from the enclosure surface and that have a different height from the plurality of primary protrusions relative to the enclosure surface.

13. The assembly of claim 12, wherein each primary protrusion comprises an elongated body that provides support to the one or more battery cells, and wherein adjacent primary protrusions are spaced apart from each other to define fluid flow channels, and wherein the plurality of secondary protrusions comprise discrete dimples that are spaced apart from each other within the fluid flow channels.

14. A method comprising:
providing a first housing component and a second housing component that cooperates with the first housing component to provide an enclosed internal cavity;
positioning at least one cell stack including one or more battery cells within the enclosed internal cavity;
forming a first plurality of guide features on at least one of the first housing component and the second housing component; and
forming a second plurality of guide features on the at least one of the first housing component and the second housing component.

15. The method of claim 14, wherein the at least one of the first housing component and the second housing component comprises an inner surface that faces the enclosed internal cavity, and including:
defining the first plurality of guide features with a first height relative to the inner surface; and
defining the second plurality of guide features with a second height relative to the inner surface, wherein the second height is less than the first height.

16. The method of claim 14, wherein the at least one of the first housing component and the second housing component comprises an inner surface that faces the enclosed internal cavity, and including forming the first plurality of guide features as mechanical supports for the one or more battery cells.

17. The method of claim 15, including forming the first plurality of guide features as discrete elongated bodies that extend outwardly of the inner surface to provide fluid flow channels.

18. The method of claim 17, wherein the discrete elongated bodies each extend away from the inner surface to a distal surface, and including covering the distal surface with a thermal interface material and forming an isolating structure between the first plurality of guide features and the one or more battery cells.

19. The method of claim 14, wherein the other of the first housing component and the second housing component includes a set of the first plurality of guide features and a set of the second plurality of guide features.

20. The method of claim 19, wherein the first housing component and the second housing component comprise an inner surface that faces the enclosed internal cavity, and including:
forming the first plurality of guide features as a plurality of primary protrusions extending away from the inner surface, wherein each primary protrusion comprises an elongated body that provides support to the one or more battery cells, and wherein adjacent primary protrusions are spaced apart from each other to define fluid flow channels; and
forming the second plurality of guide features as a plurality of secondary protrusions extending away from the inner surface and that have a different height from the plurality of primary protrusions, wherein the plurality of secondary protrusions comprise discrete dimples that are spaced apart from each other within the fluid flow channels.
